(19) United States
(12) Patent Application Publication
(10) Pub. No.: US 2008/0281867 A1
(43) Pub. Date: Nov. 13, 2008

(54) Creation of Digital Program Playback Lists in a Digital Device Based On Hierarchal Grouping of a Current Digital Program

(76) Inventors: Scott Allan Kendall, Lexington, KY (US); Anthony Edward Stuart, Zionsville, IN (US)

Correspondence Address: Joseph J. Laks;Thomson Licensing LLC, 2 Independence Way, Patent Operations, PO Box 5312, PRINCETON, NJ, 08543, US

(21) Appl. No.: 11/884,817

(22) PCT Filed: Dec. 1, 2005
(86) PCT No.: PCT/US2005/043379

§ 371 Date: Apr. 10, 2008

Related U.S. Application Data
(60) Provisional application No. 60/656,870, filed on Feb. 24, 2005.

(51) Int. Cl. G06F 17/30

(52) U.S. Cl. 707/104.1; 707/E17.009

(57) ABSTRACT

Playback list creation for digital programs in a digital device utilizes navigation path used to locate a particular digital program in a hierarchally-ordered grouping of digital programs, the grouping based on organization parameters of the digital program. The playback list is created from digital programs within the navigation path used to reach the selected digital program. The playback list may be shuffle-played or played in order. Playback of a different digital program causes changes to the navigation path, which then changes the playback list. In an MP3 player, for example, ID3 tag attributes are used as organization parameters to provide hierarchal grouping of digital audio files.

### BACKGROUND

1. Field of the Invention

The present invention relates to the creation of playback lists of digital programs in a digital apparatus and, more particularly, to playback list creation that utilizes hierarchal grouping of digital program data for playback list creation.

2. Background Information

Audio and video programming, in the form of music and movies for example, is available as digital data which is easily stored and played on various types of digital devices. The variety of digital devices capable of storing and playing audio and video digital programming is increasing. Portable devices that can process digitally encoded audio data stored on solid state memory devices or miniaturized hard drive device are quite popular.

Digital audio devices such as MP3 players, for example, allow a user to load thousands of songs, but accessing and listening to those songs in a way that users will find appealing other than by album or artist alone has been an ongoing problem. For this reason, MP3 players allow a user to select songs from a collection of songs and create a playback list of those songs (playlist). The player is then instructed to play the songs on the list. The user can thus compile a custom “album” or list of songs. As an example, a user might have a playlist called “workout”, one called “dinner date”, and another called “reading music.” The problem with this approach is that users have to create these lists manually, and that takes time and effort. Another problem with this approach is that the playlist is static and locks a user into listening to the same songs without allowing them to explore the full potential of his or her music collection. Playlist editing is non-existent to cumbersome at best.

As such, most MP3 players have what is known as a random or shuffle mode for song playback. A “Shuffle All Songs” method that is used by most MP3 players is poor at best since, for at least one reason, the variety of songs stored by the player may be immense. An individual may have varied tastes in music and may therefore listen to hip hop when working out, jazz when entertaining a date, and classical while reading. A “Shuffle All Songs” method means jazz may be followed by hip hop that may be followed by classical, etc. For this reason, MP3 players and software systems allow users to create playlists manually, which have the problems noted above.

Some MP3 players implement several methods of song playback that are an improvement to the approach described above. One method allows the user to “Shuffle Album.” The player picks an album at random and plays all the songs on that album in album order. Then, the player picks another album at random and plays its songs in album order. Problems similar to the above-described methods exist for this method because a hip hop album may be followed by a classical album. A second method allows users to pare down a playlist by selecting all songs in a particular category such as genre, album, artist or the like. However, these players ultimately order the songs based primarily on album alphabetic order and then secondarily on song order in the album.

It would be desirable for a digital device to provide an improved method for creating a playback list of digital programs.

### SUMMARY

A playback list of digital programs in a digital device is created based on hierarchal grouping of organization parameters of a selected digital program. Hierarchal grouping forms navigation paths that a user utilizes to locate a particular digital program for playback. The playback list is created from digital programs within the navigation path used to reach a selected digital program. The resulting playback list is shuffled during playback.

In one form, the present invention provides a method for creating a playback list in a digital device. The method includes: (a) storing a plurality of digital programs associated with the digital device with each one of the plurality of digital program having a set of a plurality of organization parameters associated therewith, the plurality of digital programs categorized into hierarchal groups based on the organization parameters; (b) navigating to and playing a particular digital program of the plurality of digital programs; (c) generating a dynamic shuffle playback list in response to user selection of a dynamic shuffle mode, the playback list including digital programs included in a navigation path through the hierarchal grouping used to reach the particular digital program; and (d) playing the digital programs in the playback list after playing of the particular digital program.

### BRIEF DESCRIPTION OF THE DRAWINGS

The above mentioned and other features and objects of this invention, and the manner of attaining them, will become more apparent and the invention itself will be better understood by reference to the following description of one embodiment of the invention taken in conjunction with the accompanying drawings, wherein:

FIG. 1 is a block schematic diagram of an exemplary digital apparatus, embodied as a portable digital audio data (MP3) player, that implements the principles of the present invention;

FIG. 2 is a top view of the portable audio data player of FIG. 1;

FIG. 3 is a back view of the portable audio data player of FIG. 1;

FIG. 4 is a right side view of the portable audio data player of FIG. 1;

FIG. 5 is an exemplary screen depiction of a top level view of categorized digital audio (music) files on the digital audio player of FIG. 1 illustrating an exemplary manner of categorization of music files and a starting point of navigation for the dynamic creation of a playlist in accordance with the present principles;

FIG. 6 is an exemplary screen depiction of an Artist level categorization of music files of the digital audio player of FIG. 1 and illustrating a navigation level in the grouped hierarchy of music in accordance with the present principles;

FIG. 7 is an exemplary screen depiction of an Artist/Album/Album Songs categorization of music files of the digital audio player of FIG. 1 and illustrating a navigation level in the grouped hierarchy of music in accordance with the present principles;

FIG. 8 is a flowchart of a simplified exemplary manner of operation according to the principles of the present invention; and

FIG. 9 is a flowchart of an exemplary manner of operation according to the principles of the present invention.

Corresponding reference characters indicate corresponding parts throughout the several views. Although the drawings represent an embodiment of the invention, the drawings are not necessarily to scale and certain features may be exaggerated in order to better illustrate and explain the present invention. The exemplification set out herein illustrates one embodiment of the invention, in one form, and such exemplification is not to be construed as limiting the scope of the invention in any manner.

### DESCRIPTION OF THE PREFERRED EMBODIMENT

The embodiment disclosed herein is not intended to be exhaustive or limit the invention to the precise form disclosed, but rather in an exemplary manner so that others skilled in the art may utilize its teaching.

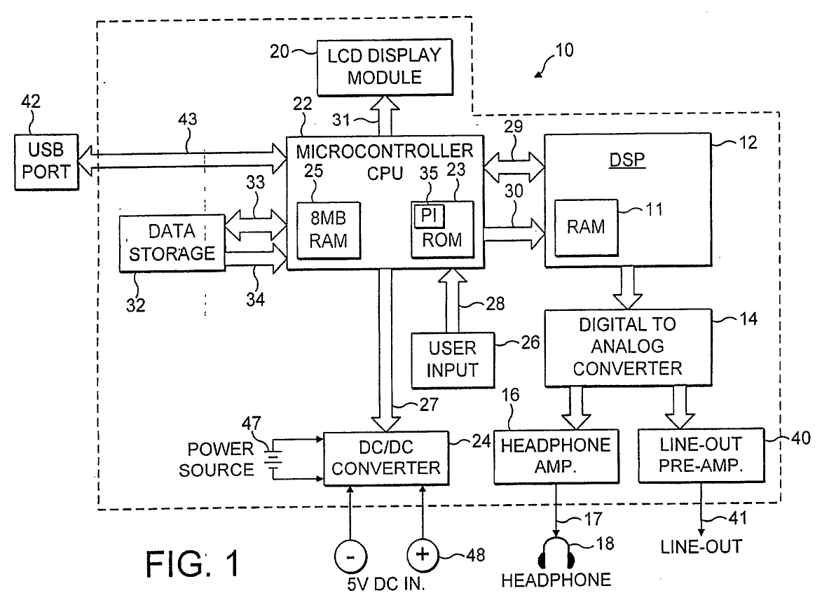

FIG. 1 depicts a block diagram of a digital device that is configured, operable and/or adapted to implement and/or embody the principles of the present invention. Particularly, FIG. 1 is a block diagram of a digital device embodied as a portable digital audio data player 10 and, more particularly, to an MP3 digital audio data player. It should be appreciated that the portable digital audio data player 10 is only exemplary of digital audio players and digital devices in general that store and/or play digital programs such as digital audio and/or video files and in which playback lists (playlists) for the digital audio and/or video files may be created and maintained. Moreover, while the digital audio play 10 may be capable of utilizing any one of a number of digital encoding schemes, the present digital audio player 10 will be described in connection with the MP3 encoding scheme.

The general arrangement and operation of the various elements and/or components of the portable audio data player 10 are described herein both in general and in the context of the present invention. However, the details of the various elements of audio data player 10 are well known to those skilled in the art and will not be discussed in detail here. Audio data player 10 comprises microcontroller (controller) 22 that controls the various elements and the overall operation of audio data player 10, including transferring data from data storage 32, through buffer memory 25, and to audio decoder digital signal processor (DSP) 12. Microcontroller 22 includes a suitable amount of memory 23, for storing various instruction sets, programs and the like (program instructions) 35 for controlling the operation of audio data player 10 including carrying out or implementing the principles of the present invention. As pointed out in greater detail below, the method according to the principles of the subject invention may be utilized by other types of digital devices or components that store and/or play digital programming (e.g. digital audio data, digital video data) from a plurality of pre-recorded (stored) digital content or programming (data). An LCD display module 20 is in communication with the microcontroller 22 via bus 31 for display of various data and/or information regarding the player 10. This includes the display of menus for user selection of parameters and/or operating conditions and/or the like.

DSP 12 may be programmed to perform a variety of signal processing functions during playback of a selected digital audio data file as well as selective segments or portions (i.e. audio clips) of digital audio data files. In this case, the functions that DSP 12 performs during playback include, but are not limited to, decoding digital audio data files, volume control, digital sound equalization, and sample conversion. The DSP 12 also performs other functions necessary to implement the principles of the subject invention as well other typical functions not necessarily discussed herein. In that regard, DSP 12 includes onboard memory 11, wherein the decoder files, audio data files, audio clips, equalizer mode selection, and various other required data are loaded during playback. In the case of MP3 encoded digital audio data files, the DSP 12 is operable to perform MP3 decoding.

The decoder files comprise programs that control the MP3 decoding operations by DSP 12 of the digital audio data files including recognizing the MP3 ID3 tag or data associated with the digital audio data file. Both the digital audio data files and the decoder files may be stored in data storage 32. The decoder files including the programs are transferred to DSP memory 11 from data storage 32. Alternatively, the decoder files may be stored in ROM 23, RAM 11 or other suitable storage device of player 10. Further, the decoder files and other system files and programs may also be stored in RAM 25, ROM 23 or other suitable storage devices coupled to DSP 12.

The digital audio data and decoder programs stored in data storage 32 may be encrypted, requiring that decoding program files and audio data files be decrypted by DSP 12 using one or more decryption keys. The decryption keys may also be stored in data storage 32 and may be security linked to the particular storage device or some other coded component of audio data player 10 so that audio data files encrypted for use on a particular audio data player may only be decrypted and played by that particular audio data player.

As a selected digital audio data file is decoded, DSP 12 provides the decoded data stream to a digital to analog (D/A) converter 14. The D/A converter 14 converts the digital output of DSP 12 into an analog signal and provides the analog signal to headphones amplifier 16 and a lineout pre-amp 40. The analog signals are amplified and provided to a lineout jack 41 and a headphones jack 17, both disposed on housing 13 of audio player 10.

The digital audio player 10 is adapted to operate with data storage 32. The data storage 32 may be a hard drive disk (HDD), static memory, a combination or otherwise that is adapted to store various digital data files, including encoded digital audio data files, decoder files for controlling the decoding operation of DSP 12, playlist files/data, ID3 data, navigation path data, hierarchical order data, and/or other data as appropriate or necessary. A large amount of data can be readily transferred between data storage 32 and microcontroller 22 through data bus 33. Buffer memory 25 operates as a circular data buffer to prevent interruption of audio playback caused by a skip or other similar moving data storage device data transfer delays.

Moreover, buffer memory 25 receives and temporarily stores the MP3 songs from the data storage 32 as selected by the user or through automatic selection based on a playlist. Buffer memory 25 then provides the digital audio data to DSP 12 for sequential playback. Thus, buffer memory 25 continuously receives digital audio data for playback. Buffer management is desired in order to avoid response time problems during audio playback.

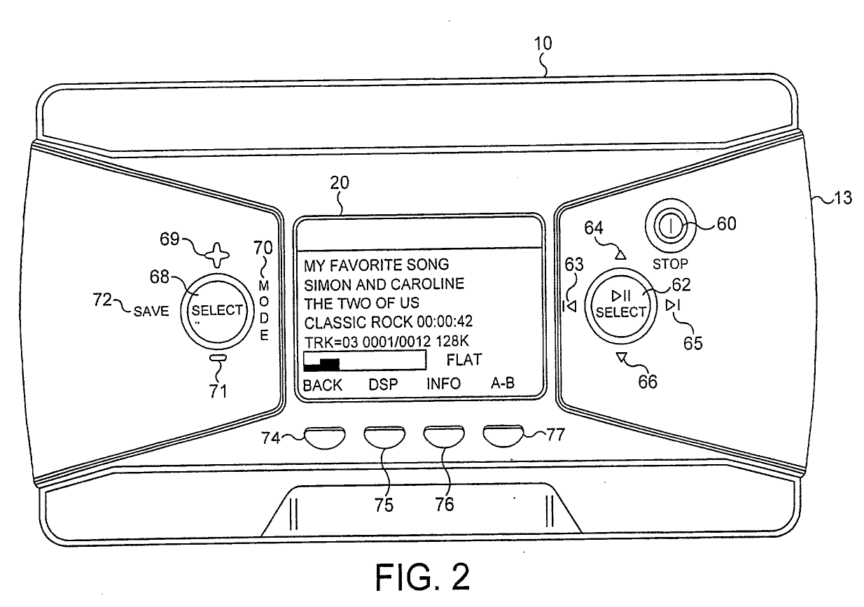

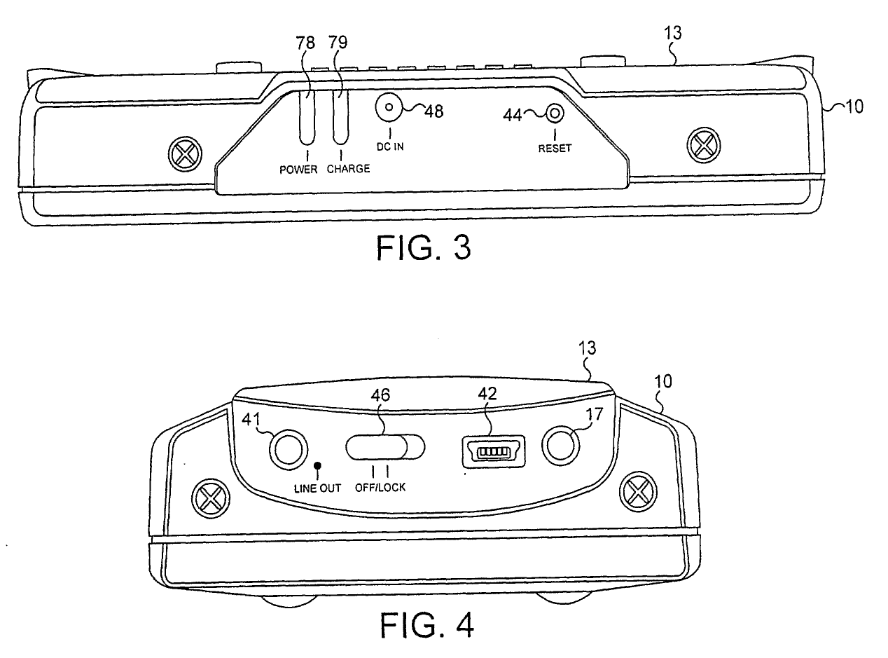

FIGS. 2-4 illustrate an exemplary embodiment of the displays, buttons, switches, indicators and ports that may be disposed on a housing 13 of digital data player (e.g. digital audio or MP3 player) 10 that are used as indicated herein to carry out the principles of the present invention. Particularly, one or more of the various buttons constitute a user interface or user input device for allowing the user to make selections appropriate for the particular mode of digital audio player 10 such as selection of shuffle or repeat. Particularly, referring to FIG. 2, user input 26 comprises a plurality of buttons 44 (FIG. 3), 46 (FIG. 4) and 60-77 disposed on housing 13 of audio data player 10 for allowing user input to on-screen menus and otherwise.

User input 26 may also comprise other input devices known in the art, for example, keyboard, voice activated touch pad, and touch screen input devices. Two multi-way switches comprise buttons 62-66 and 68-72. Soft keys 74-77 are multi-function buttons whose function change for various user interface menu displays. Audio data player 10 also includes the display 20 disposed on housing 13. As shown in FIG. 2, display 20 displays information regarding the audio data player 10, data and/or user selection menus, playback information, song information and/or the like, the songs being played, the function of soft keys 74-77, and various status information associated with audio data player 10, such as the playback status shown in FIG. 2 as well as various menus. The display 20 indicates the category, Classic Rock, of the song “My Favorite Song” from the album “The Two of Us” from the artist “Simon and Caroline.” Other information or data such as an equalizer may be shown.

In FIG. 2, STOP/POWER button 60 allows the user to stop playback and to turn audio data player 10 on and off. PLAY/PAUSE button 62 allows the user to start playback and to pause playback. Left arrow button 62 allows a user to move a highlight left when using the menu, and to skip back to the previous audio data file or audio clip, or scan backward in the present audio data file when playing music. The right arrow button 65 allows the user to move a highlight right when using the menu, skip forward to the next audio data file or audio clip, and scan forward in the current audio data file when playing music. Up arrow button 64 allows the user to move the highlight up when using the menu. Down arrow button 66 allows the user to move the highlight down when using the menu. Referring still to FIG. 2, SELECT button 68 allows the user to select a highlighted item. Volume up button 69 increases the playback volume level for headphone 18 and volume down button 71 decreases the volume level. MODE button 70 allows the user to select a particular playback mode, including REPEAT and SHUFFLE, Equalizer Mode, and playlist creation. Soft keys 74-77 select the menu item that appears just above each button at the bottom of display 21.

Referring to FIG. 3, when digital audio player 10 is on, POWER indicator 78 illuminates. CHARGE indicator 79 lights when the power source 47 is charging. CD IN jack 48 provides 5 volt DC from an AC adaptor to power audio data player 10. RESET button 44 allows the user to reset all of the audio data player settings to the factory defaults.

Referring now to FIG. 4, OFF/LOCK switch 46 allows the user to make buttons 60-77 inactive when switch 46 is slid to the locked position. LINEOUT jack 41 allows a user to connect the audio data player to a separate audio system. Headphones jack 17 allows the user to play the decoded audio on headphones 18. USB port 42 provides connection of audio data player 10 to a PC or other similar device using a USB cable.

The digital audio data player 10 as described above is operable to store digital audio programs such as MP3 files and such will now be described with reference to same. Each MP3 file has ID3 tag elements or attributes that can be used as organization parameters for each MP3 file (song). Each song has ID3 attributes of Song Title, Artist, Album and Year. Additionally, the ID3 attribute may have user defined categories such as playlists. Other attributes may be included. The attributes provide a manner of classification, organization, categorization or grouping of songs. Songs with the same designation for Genre, for example, are considered to have a similar sound quality. Songs with the same Artist attribute were written or performed by the same person or group. Songs with the Album attribute were produced on a single record/CD/Tape album. Songs with the same Year attribute were produced in the same year. Songs from the same user defined playlist are a custom group of songs that have some relationship as defined by the user. As such, these attributes are used as organization parameters.

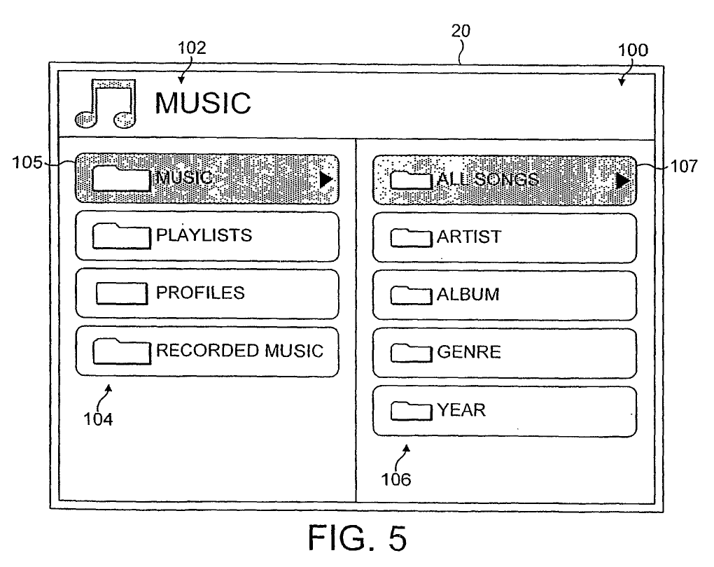

The digital audio player 10 categorizes songs based on these tags and organizes the songs into folders such that one can search songs by a particular category, i.e. Artist, Album, Genre, Year and Song Title. For example, and referring to FIG. 5, a screen menu 100 as shown on the display 20 is depicted, wherein a user has selected Music 102 as the type of digital program or programming to play. Music may be considered the root, main or beginning directory or path of an audio file navigation path (navigation path). The menu 100 provides the user a plurality of choices 104 under the main heading Music 102. The selection of a choice 104 changes the right side portion of the menu 100. In this case the category Music 105 has been selected which provides the groupings of organization parameters or attributes 106 for Music. Each grouping, i.e. All Songs, Artist, Album, Genre and Year may be considered a next portion of a navigation path. Here, the grouping All Songs 107 has been selected by the user.

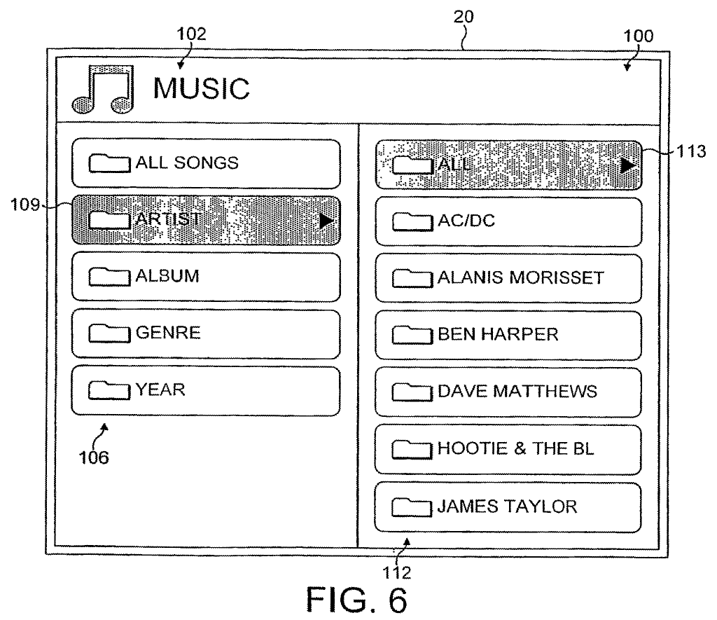

FIG. 6 depicts a screen menu 110 as shown on the display 20 of the player 10 in response to user selection of the All Songs 107 category or grouping. The menu 110 allows the user to select one of the category or grouping 106 of All Songs, Artist, Album, Genre and Year, and may be considered a next portion of a navigation path. Here, the user has selected Artist 109 under All Songs bringing up the right side menu portion of the menu 110. The sub-groupings 112 allow the user to select an Artist as listed or All 113 as has been chosen.

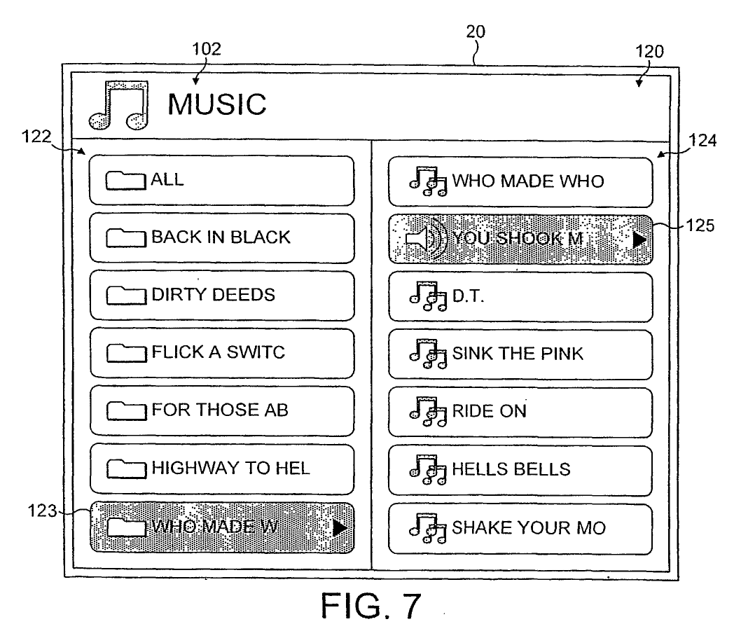

FIG. 7 depicts a screen menu 120 as shown on the display 20 of the player 10 in response to the selection of the All subgroup 113 of Artist group 106. The menu 120 provides a further sub-grouping 122 (next portion of a navigation path) of selections. Here, the album Who Made Who 123 has been selected. This brings up the right side portion of the menu 120, consisting of the plurality of individual songs 124 stored on the player 10. The song You Shook Me All Night Long 125 has been selected as a current song to be played.

Each folder (selection and as indicated by the folder icon) includes the choice of “All” which, when selected, flattens the songs under that category into a list of songs. However, the choice of All is not available in the folder if the items in the folder are individual songs (see, e.g. FIG. 7). The flattening refers to arranging all the songs along a particular navigation path, or organization hierarchy, into a single list, that is, reducing the list of audio programs to a single level within an organization parameter. This is described further below.

It can be seen that the various groupings and sub-groupings are in hierarchal order and as such create navigation paths starting from “Music” to a particular song. Thus, a particular song may be “reached” for play by the device through different navigation paths. These different navigation paths, however, provide songs to populate a dynamic shuffle playback list (playlist) in accordance with the present principles.

An exemplary hierarchal grouping of songs based on the organization parameters of the song as described above with reference to the screen displays of FIGS. 5-7 is as follows. The navigation path as a result of the hierarchal grouping is also given. Particularly, each main category 106 corresponding to the organization parameters of songs (Music) is described.

For All Songs, the navigation path is All Songs from the Music folder (“All Songs/”). All songs are provided in alphabetical order.

For Artist, the navigation path is Artist from the Music folder (“Music/Artist/” or simply “Artist/”). A list of all the artists that have a song on the MP3 player 10 is provided in alphabetical order. Subcategories under Artist include All and Artist Chosen, with further subcategories of All and Album Chosen under Artist Chosen. Selection of All under Artist provides a navigation path of “Artists/All”. A list of all songs on the MP3 player 10 is provided and ordered primarily by Artist (in alphabetical order), secondarily by Album (in alphabetical order) and tertiarily by songs in album order. Selection of Album Chosen under Artist provides a navigation path of “Artist/Album Chosen”. A list of albums by that Artist (the artist chosen) is provided in alphabetical order. A selection of All under Artist provides a navigation path of “Artist/All”. A list of all songs by that Artist is provided and ordered primarily by Album (in alphabetical order) and secondarily by songs (in alphabetical order). A selection of Album Chosen under All provides a navigation path of “Artist/All/Album Songs”. A list of all songs on that album is provided and ordered primarily by songs in album order.

For Albums, the navigation path is Albums from the Music folder (“Music/Album/” or simply “Album/”). A list of all the albums on the MP3 player 10 is provided in alphabetical order. Subcategories under Album include All and Album Chosen. Selection of All under Albums provides a navigation path of “Albums/All”. A list of all albums on the MP3 player 10 is provided and ordered primarily by Album (in alphabetical order), and secondarily by songs in album order. Selection of Album Chosen under Albums provides a navigation path of “Albums/Album Songs”. A list of all songs on that album is provided in album order.

For Genre, the navigation path is Genre from the Music folder (“Music/Genre/” or simply “Genre/”). A list of all the genres in alphabetical order for which the player 10 has songs is provided. Subcategories under Genre include All and Genre Chosen, with further subcategories of All and Artist Chosen under Genre Chosen. Selection of All under Genre provides a navigation path of “Genre/All”. A list of all songs on the MP3 player 10 is provided and ordered primarily by Genre (in alphabetical order), secondarily by Artist (in alphabetical order), tertiarily by Album (in alphabetical order) and quaternarily by song in album order. Selection of Genre Chosen under Genre provides a navigation path of “Genre/Genre Chosen”. A list of artists in that genre is provided in alphabetical order. A selection of All under Genre Chosen provides a navigation path of “Genre/Artists/All”. A list of all songs of that genre is provided and ordered primarily by Artist (in alphabetical order), secondarily by Album (in alphabetical order) and tertiarily by song in album order. A selection of Artist Chosen under Genre Chosen provides a navigation path of “Genre/Genre Chosen/Artist Chosen”. A list of albums by that artist is provided in alphabetical order. Under Artist chosen, the user can select All or Album Chosen. A selection of All provides a navigation path of “Genre/Genre Chosen/Artist Chosen/All”. A list of all songs is provided by that artist ordered primarily by album (in alphabetical order) and secondarily by song in album order. A selection of Album Chosen provides a navigation path of “Genre/Genre Chosen/Artist Chosen/Album Chosen/Album Songs”. A list of all songs on that album is provided in album order.

For Year, the navigation path is Year from the Music folder (“Music/Year/” or simply “Year/”). A list of calendar years in number order is provided only for those years in which there is one or more songs having that attribute store in the player 10. Subcategories under Year include All and Year Chosen. Selection of All under Year provides a navigation path of “Year/All”. A list of all songs on the MP3 player 10 is provided and ordered primarily by year (in numeric order) and secondarily by songs in alphabetical order. Selection of Year Chosen under Year provides a navigation path of “Year/Songs of Year”. A list of all songs from that year is provided in alphabetical order.

In accordance with the principles of the present invention, a user may select a play mode herein designated dynamic shuffle. The dynamic shuffle mode creates a playback list based on the hierarchal grouping of a currently selected song. Since hierarchal grouping equates to navigation path, dynamic shuffle creates a playback list based on how a user navigated to a currently selected (or playing) song. A user may turn dynamic shuffle on before or during playing of a song.

When dynamic shuffle is set to “On”, category or grouping is set as a result of the way a user finds or reaches a song through the navigation structure of the hierarchal groupings that are based on the organization parameters of the audio files termed the navigation path. Once playing, the user can change songs on the fly and the player will recalculate the navigation path and thus the playback list of songs. Calculation of the new navigation path and playback set occurs between the end of the current song and the beginning of the next song. If the user is in this menu at the end of a song, the song is paused until the user exits back to the Playback Screen.

Thus, when a user finds a song that he likes, turning dynamic shuffle on will present songs on a shuffle basis from songs that are within the navigation path. This provides songs that are alike in the sense of being in the same group or grouping. In this manner, if a user is listening to a song from a particular genre, songs from different genres will not be selected for play.

Where the dynamic shuffle setting is Off, the selection of songs are played in the order they appear in the flattened list where play was started. If the user uses a navigation path to get to the song, the dynamic shuffle method will remain off.

However, if a previously created playlist has been selected for play, there has been no navigation path and dynamic shuffle is not selectable. This is also true for tagged songs.

Alternatively, a dynamic playback list may be generated in the manner described herein but which is not shuffled during playback, but played in order within the navigation path.

An exemplary manner of operation of the dynamic shuffle mode is as follows. In the All Songs grouping of Music, all of the songs that are in the user selected navigation path are shuffled if the navigation path is one of Genres/All, Artists/All, Albums/All, Year/All or All Songs/. In the Genre grouping of Music, all of the songs that are in the user selected navigation path are shuffle played. Playback is restricted in Genre to songs that have the same Genre as the song currently being played. This will automatically be chosen if the navigation path is Genre/Artist/All.

In the Artist grouping of Music, all of the songs that are in the user selected navigation path are shuffle played. Playback is restricted in Artist to songs by that artist as the song currently being played. A navigation path may be Genre/Artist/All. This will automatically be chosen if the navigation path is Genre/Artist/Album/All or Artist/Album/All. If the previous navigation path was Genre/ . . . then the navigation path will change to Genre/Artist/Album/All. All other paths will change to Artist/Album/All.

In the Albums grouping of Music, all of the albums that are in the user selected navigation path are shuffle played. Songs within albums are played back in album-order. This will automatically be chosen if the navigation path is Genre/Artist/Album/Album Songs, Artist/Album/Album Songs or Album/Album Songs. If the previous navigation path was Genre/ . . . then the navigation path will change to Genre/Artist/Album/Album Songs. If the previous navigation path was Artist/ . . . then the navigation path will change to Artist/Album/Album Songs.

In the Year grouping of Music, all of the songs that are in the user selected navigation path are shuffle played. Playback is restricted in Year to songs that were produced in the year of the song currently being played. This will automatically be chosen if the navigation path is Year/Songs of Year. Navigation path will change to this path from any other path if this setting is chosen when a song is being played. Other schemes consistent with the present principles are contemplated.

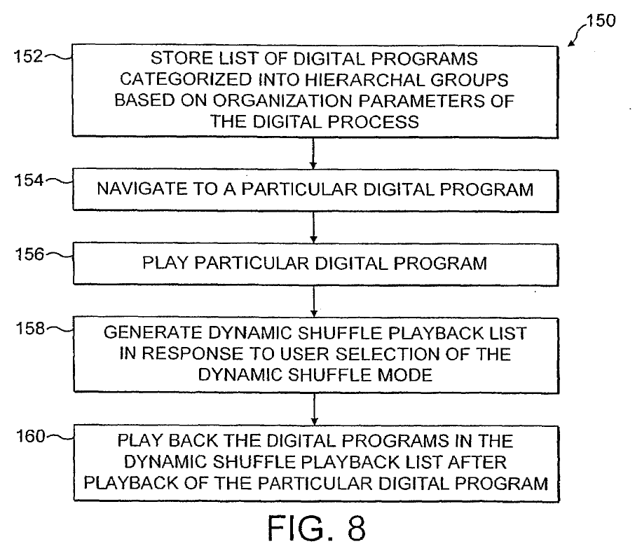

Referring now to FIG. 8, there is depicted a flowchart, generally designated 150, depicting an exemplary manner for implementing the present invention in a digital device in accordance with the principles of the present invention. Particularly, the flowchart 150 of FIG. 8 illustrates a method for generating a shuffle playback list or playlist in a digital device.

In box 152, the digital device stores a list of digital programs (digital data or files such as MP3 files) that are categorized into hierarchal groups based on organization parameters of the digital programs. For example, MP3 files have ID3 tag elements, attributes or categories that may be used as organization parameters. The MP3 files have attributes of Song Title, Artist, Album and Year. These attributes may be used to create groups and subgroups with individual songs associated with each group and/or subgroup. These groupings create navigation paths to and from particular programs.

In box 154, a user navigates to a particular digital program. Navigation is aided by on-screen display of navigation menus. Thereafter, in box 156, the player plays the selected (particular) digital program. In response to user input for Shuffle Mode, in box 158 the player generates a dynamic shuffle playback list. The dynamic shuffle playback list (playlist) is a list of digital programs (e.g. songs) in the user selected navigation path that will be played on a shuffle basis. The list may be based on a flattened list. In box 160, the digital programs are in the dynamic shuffle playback list are played after the end of play of the particular digital program.

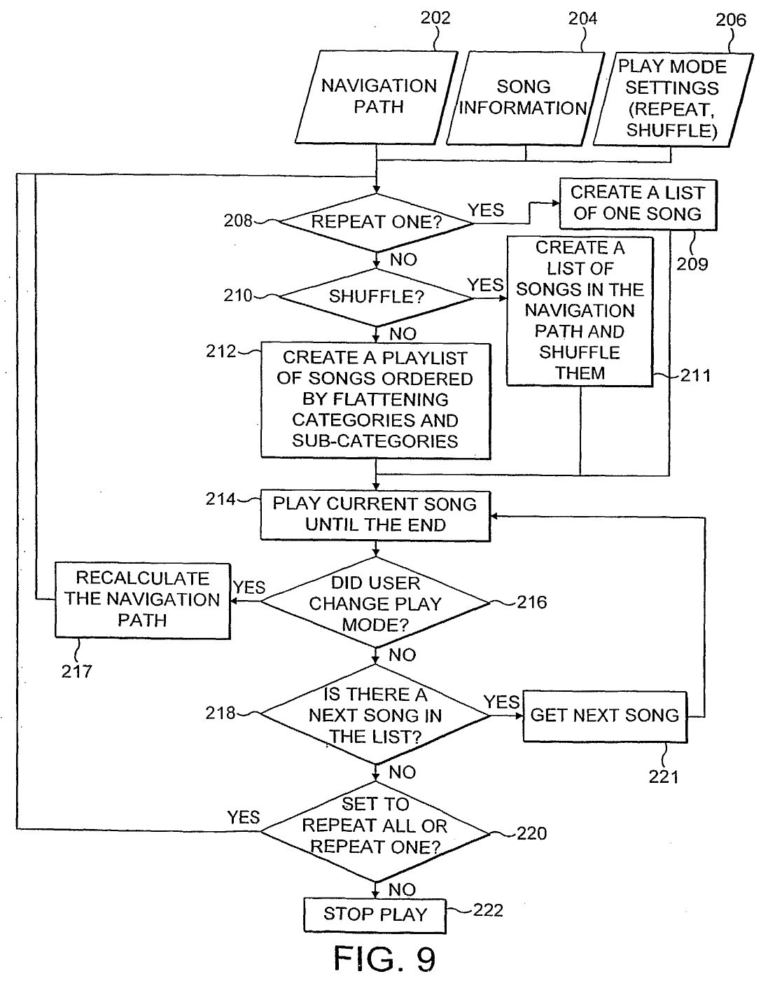

Referring now to FIG. 9, there is depicted a flowchart, generally designated 200, depicting an exemplary process level flow for implementing the present invention in a digital device, particularly a digital audio device (e.g. MP3 player 10) in accordance with the present principles. Particularly, the flowchart 200 depicts a manner in which the player plays selected songs and generates dynamic shuffle playback lists (playlists) in response to user input during song playback.

In box 202, a navigation path is determined. Particularly, a navigation path taken by a user to reach a particular song (audio data file) to be played is determined. When selecting a song for listening, the user may navigate through the songs as categorized or grouped by the player, such as according to ID3 tag data. In box 204, the chosen or selected song information or data, including category or grouping data, is obtained. In box 206, the current play mode is determined.

In decision box 208, the player determines if the user has selected, or the player is in, the Repeat One Mode (i.e. the repeat of only the currently selected/playing song). If Repeat One is on (i.e. “Yes”), then the player creates a play list of the one song, box 209, and thereafter process flow continues to box 214. In decision block 208, if the Repeat One is off (i.e. “No”), then in decision box 212, the player determines whether the user has selected, or the player is in, the Shuffle Mode (i.e. to randomly select and play songs).

If Shuffle is on (i.e. “Yes”), then the player creates a list of songs in the navigation path and shuffles them for play, box 211, and thereafter, process flow continues to box 214. If Shuffle is off (i.e. “No”), then process flow continues to box 214. In box 214, the selected song is played until its end.

After the songs end, in decision box 216 the player determines whether the user has changed the play mode. If the user has changed the play mode (i.e. “Yes”), the navigation path is recalculated, box 217) and thereafter process flow begins again at decision box 208. If the user has not changed the play mode (i.e. “No”), then, in decision box 218 the player determines whether there is a next song in the play list.

In decision box 218, if the player determines that there is a next song on the list (i.e. “Yes”), then, in box 221, the player retrieves the next song for playing (box 214). If, in decision box 218, the player determines that there is not a next song on the list (i.e. “No”), then process flow continues to decision box 220.

In decision box 220, the player determines whether the player is set to a Repeat All or a Repeat One mode. If the player is in a repeat mode (i.e. “Yes”), then process flows back to decision box 208. If, in decision box 220, it is determined that the player is not in a repeat mode (i.e. “No”), then play is stopped, box 222.

It should be appreciated that the flowcharts described above and depicted in FIGS. 8 and 9 provide manners of exemplary operation of the present invention as described herein. The present invention may be implemented utilizing less or different steps than all of the steps of the flowcharts. Moreover, the particular order may be changed as appropriate. As well, subsets of the above procedures may implement the principles of the subject invention rather than the entire procedure. Variations are also contemplated.

While this invention has been described as having a preferred design, the present invention can be further modified within the spirit and scope of this disclosure. This application is therefore intended to cover any variations, uses, of adaptations of the invention using its general principles. Further, this application is intended to cover such departures from the present disclosure as come within known or customary practice in the art to which this invention pertains and that fall within the limits of the appended claims.

1. A method for creating a playback list in a digital apparatus, the method comprising the steps of:
storing a plurality of digital programs associated with the digital apparatus, each digital program having a respective set of a plurality of organization parameters associated therewith, the plurality of digital programs being grouped into hierarchal groups based on the organization parameters;
retrieving, and playing, a particular one of the digital programs in response to a user input including navigation input to select the particular one of the digital programs;
generating a dynamic shuffle playback list in response to user selection of a dynamic shuffle mode, the dynamic shuffle playback list including digital programs included in a navigation path used to reach the particular one of the digital programs; and
playing the digital programs in the dynamic shuffle playback list after playing of the particular one of the digital programs.

2. The method of claim 1, wherein the digital programs comprise audio programs and the organization parameters includes one of all songs, artist, album, genre, and year.

3. The method of claim 2, wherein the audio programs comprise MP3 audio programs.

4. The method of claim 2, further comprising the step of flattening the list of audio programs in response to a selection of the all songs parameter, the flattening comprising reducing the list of audio programs to a single level within an organization parameter.

5. The method of claim 1, wherein the step of generating the dynamic shuffle playback list is performed after selection of the all songs organization parameter.

6. The method of claim 1, further comprising the steps of:
recalculating a navigation path of a next digital program in response to user navigation to a next digital program; and
regenerating a dynamic shuffle playback list in response to recalculating a navigation path, the regenerated dynamic shuffle playback list including digital programs included in the recalculated navigation path.

7. A digital apparatus comprising:
a storage device storing a plurality of digital programs associated with the digital apparatus, each digital program having a respective set of a plurality of organization parameters associated therewith, the plurality of digital programs being grouped into hierarchal groups based on the organization parameters;
input means allowing a user to navigate, select and play a particular digital program from the plurality of stored digital programs;
control means for generating a dynamic shuffle playback list in response to user selection of a dynamic shuffle mode, the dynamic shuffle playback list including digital programs included in a navigation path used to reach the particular digital program; and
processor means for playing the digital programs in the dynamic shuffle playback list after playing of the particular one of the digital program.

8. The digital apparatus of claim 7, wherein the storage device stores a plurality of digital programs comprising audio programs with the organization parameters including one of all songs, artist, album, genre, and year.

9. The digital apparatus of claim 8, wherein the audio programs comprise MP3 audio programs.

10. The digital apparatus of claim 8, wherein the control means flattens the audio programs in response to user selection of the all songs parameter, the flattening comprising reducing a list of the audio programs to a single level within an organization parameter.

11. A digital audio player comprising:
a storage device storing a plurality of digital audio programs, each one of the plurality of digital audio program having a respective set of a plurality of organization parameters associated therewith, the plurality of digital audio programs being grouped into hierarchal groups based on the organization parameters;
an input device allowing a user to navigate to, select and play a particular digital audio program from the plurality of stored digital audio programs;
a dynamic shuffle playback list generator responsive to user input selection of a dynamic shuffle playback mode to create a dynamic shuffle playback list, the dynamic shuffle playback list including digital audio programs included in a navigation path used to reach the particular digital audio program; and
playback means configured to play the digital audio programs in the dynamic shuffle playback list after playing of the particular one of the digital audio program.

12. The digital audio player of claim 11, wherein the organization parameters include at least one of all songs, artist, album, genre, and year.

13. The digital audio player of claim 12, wherein the digital audio programs comprise MP3 digital audio programs.

14. The digital audio player of claim 12, further comprising processing configured to flatten the digital audio programs in response to user selection of the all songs parameter, the flattening comprising reducing a list of the digital audio programs to a single level within an organization parameter.
